(19) United States
(12) Patent Application Publication
(10) Pub. No.: US 2009/0055193 A1
(43) Pub. Date: Feb. 26, 2009

(54) METHOD, APPARATUS AND COMPUTER CODE FOR SELECTIVELY PROVIDING ACCESS TO A SERVICE IN ACCORDANCE WITH SPOKEN CONTENT RECEIVED FROM A USER

(75) Inventors: ARIEL MAISLOS, Sunnyvale, CA (US); Ruben Maislos, Or-Yehuda (IL); Eran Arbel, Cupertino, CA (US); Ron Hecht, Raanana (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Pudding Holdings Israel Ltd., Kefar-Saba (IL)

(21) Appl. No.: 12/034,736

(22) Filed: Feb. 21, 2008

Related U.S. Application Data
(60) Provisional application No. 60/891,042, filed on Feb. 22, 2007.

(51) Int. Cl. G10L 11/00

(52) U.S. Cl. 704/273

(57) ABSTRACT

Apparatus, methods and computer-readable medium for authenticating a user and selectively providing access to a computer service are described herein. In some embodiments, a) a user input is solicited; b) a voice response to the input soliciting; is received on or from a client device, c) if a determination is made, in accordance with one or more speech delivery features of the voice response, that the voice response is a live human voice response, the client device is permitted to access a computer service; and d) otherwise, client device access to the computer service is denied. Optionally, the access may be permitted only to a pre-determined gender or a pre-determined age group.

### CROSS-REFERENCE TO RELATED APPLICATIONS

This patent application claims the benefit of U.S. Provisional Patent Application No. 60/891,042 filed Feb. 22, 2007 by the present inventors.

### FIELD OF THE INVENTION

The present invention relates to a method, apparatus and computer code for distinguishing between humans and computers using voice.

### BACKGROUND OF THE INVENTION

CAPTCHA (Completely Automated Public Turing test to tell Computers and Humans Apart) is an acronym used to describe a system built to distinguish that a human is making an online transaction rather than a computer. A typical CAPTCHA relies on a problem that is asymmetrical in nature, one that is possible for a human to answer, and difficult for a computer to respond to, while still easy for a computer to generate the question. Until now, typical CAPTCHA displayed random words or letters in a distorted fashion so that they can be deciphered by people, but not by software. Users are asked to type in what they see on screen to verify they are, in fact, human.

### SUMMARY OF THE INVENTION

The present inventors are now introducing the use of voice in the challenge process. It is possible to detect whether a voice recording is computer generated or originated by a human respondent.

In one example, the user asked to read out a word or a sentence into a microphone, and by analyzing the speech input, it may be determined if the user is a machine or a human. In the same manner, the system may display a more complex challenge that requires logic, intuition, common sense, knowledge or understanding in order to respond correctly, thus adding another layer of complexity to the challenge.

It is now disclosed for the first time a method of authentication, the method comprising: a) soliciting a user input; b) receiving, on or from a client device, a voice response to the input soliciting; c) if a determination is made, in accordance with one or more speech delivery features of the voice response, that the voice response is a live human voice response, permitting the client device to access a computer service; and d) otherwise, denying client device access to the computer service.

According to some embodiments, the access permitting to the computer service of step (c) does not require a match between features of the received voice response and speech features of one or more pre-specified human individuals (i.e. of a “white-list”).

According to some embodiments, the determination that the voice response is a live human voice response is contingent on a determination that the voice response is not concatenated sound clips.

According to some embodiments, the determination that the voice response is a live human voice response is contingent on a determination that the voice response does not match electronic media content generated before a time of the soliciting.

According to some embodiments, the determination that the voice response is a live human voice response is contingent on a determination that the voice response does not include computer synthesized speech.

According to some embodiments, the determination that the voice response is a live human voice response is contingent on a determination that the voice response is not a multi-speaker voice response.

According to some embodiments, the computer service is selected from the group consisting of the provisioning of a phone call, a gaming service, an email server, and a web browsing service.

According to some embodiments, i) the input-soliciting includes presenting a dynamically-generated challenge is that is randomly-generated at least in part; and ii) the determination that the voice response is a live human response is contingent upon the voice response including a successful response to the challenge.

According to some embodiments, i) the input-soliciting includes presenting at least one challenge selected from the group consisting of: A) a request to read a sentence; B) a request to describe an image or a video clip; C) a request to answer a math problem; and D) a request to sing a song; and ii) the determination that the voice response is a live human response is contingent upon the voice response including a successful response to the challenge

According to some embodiments, the method is repeated a plurality of times for a plurality distinct human users, and the method further comprises: e) identifying words of the voice responses; f) generating, from the received voice response, a database of response from different users; and g) indexing the database by word,

It is now disclosed for the time a method of authenticating a user, the method comprising: a) soliciting a user input; b) receiving, on or from a client device, a voice response to the input soliciting; c) if a determination is made that the voice response is a live human voice response from of person of a pre-determined gender or a pre-determined age range, permitting the client device to access a computer service; and d) otherwise, denying client device access to the computer service.

It is now disclosed for the first time an apparatus for authentication, the system comprising: a) an input-soliciter operative to solicit a user input; b) an input, operative to receive, on or from a client device, a voice response to the input soliciting; and c) a service-provider operative to: i) if a determination is made, in accordance with one or more speech delivery features of the voice response, that the voice response is a live human voice response, permit the client device to access a computer service; and d) otherwise, deny client device access to the computer service.

It is now disclosed for the first time an apparatus for authentication, the system comprising: a) an input-soliciter operative to solicit a user input; b) an input, operative to receive, on or from a client device, a voice response to the input soliciting; and c) a service-provider operative to: i) if a determination is made that the voice response is a live human voice response from of person of a pre-determined gender or a pre-determined age range, permit the client device to access a computer service; and d) otherwise, deny client device access to the computer service.

### BRIEF DESCRIPTION OF THE DRAWINGS

FIG. 1 is a flow chart of an exemplary routine for providing access or denying access to a computer service.

FIG. 2 is a flow chart of an exemplary implementation of step S113.

FIG. 3 is a flow chart of an exemplary implementation of step S121.

FIGS. 4-5 are block diagrams of exemplary systems for providing access or denying access to a computer service.

### DETAILED DESCRIPTION OF EMBODIMENTS

The present invention will now be described in terms of specific, example embodiments. It is to be understood that the invention is not limited to the example embodiments disclosed. It should also be understood that not every feature of the presently disclosed apparatus, device and computer-readable code for selectively providing access to a computer service according to a voice response to a CAPTCHA challenge is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

Presently described embodiments relate to a technique for deciding whether or not to provide access to a computer or electronic service according to a voice response to a CAPTCHA challenge received from a user.

The presently-disclosed techniques and apparatus are language independent. For sake of simplicity, all examples are given in English.

Certain examples of related to this technique are now explained in terms of exemplary use scenarios. After presentation of the use scenarios, various embodiments of the present invention will be described with reference to flow-charts and block diagrams.

### Use Scenario 1

According to a first use scenario, access to email accounts are provided. In this scenario, there is a suspicion that “web-crawlers” or “robots” will register for the email accounts, rather than “humans.” According to this scenario, a CAPTCHA challenge is presented to a user via a client-side interface—for example, an image-based “reCAPTCHA™” challenge. reCAPTCHA is the process of utilizing CAPTCHA to improve the process of digitizing the text of books. It takes scanned words that optical character recognition software have been unable to read, and presents them for humans to decipher as CAPTCHA words.

According to this example, rather than having the user enter the text of the word(s) solicited by the reCAPTCHA (for example, using a keyboard), the user speaks these words, and electronic media content of the user's voice response to the CAPTCHA challenge is received.

In this example, in order for the user (or the user's client device) to be “granted access” to the electronic service, two requirements must be met. First of all, the received response to the CAPTCHA must be “correct” (i.e. the user must successfully identify the letter(s) or word(s) of the image of the reCAPTCHA challenge). Second of all, it must be determined that the received response is received by a “human speaker” rather than computer-synthesized speech and/or pre-recorded speech. The first requirement relates to “speech content features”—i.e. the letters or words of the spoken response. The second requirement relates to “speech delivery features”—i.e. how the spoken letters or words are spoken.

### Use Scenario 2

In this use scenario, the user is asked to read a sentence. According to this example, the user's providing of the correct “content” is required in order for the response to the CAPTCHA challenge to be considered “correct.” However, a “correct” response to the CAPTCHA challenge is not sufficient in order to effect a decision to provide access to the computer service (for example, an “online” service delivered via a wide-area network such as a phone network or the Internet).

In this second use scenario, “speech content features” are once analyzed used to determine if the response to the CAPTCHA is correct (for example, using a speech to text converter). In the event that the response to the CAPTCHA is “correct,” then speech delivery features may be used to determine if the provider of the spoken electronic media content is (i) a “live” human speaker (in which case the access to the computer service is provided; OR (ii) either computer-synthesized speech or concatentated speech of pre-recorded words or phrases.

Thus, in this second example, it is recognized that some fraudsters (or others) may attempt to circumvent the voice CAPTCHA by submitting a computer-created response rather than a “live” human response. One potential technique used by the fraudsters is to submit computer-generated speech. Alternatively or additionally, in order to provide a response, it is possible to: (i) maintain a database of pre-recorded words or phrases; and (ii) response to the CAPTCHA challenge using a computer program “paste together” or “concatenate” the words or phrases of the

The present inventors have (i) realized that it is possible to distinguish between “concatenated” speech and “original speech” (i.e. in accordance with one or more speech delivery features); (ii) are now disclosing that this may be used when distinguishing between a “live answer” to a CAPTCHA challenge and an automatically generated answer; (iii) may thus be used when deciding whether or not to provide a given computer service.

As will be discussed below, in different examples, one or more “speech delivery features” may be used to distinguish between “concatenated speech” and “original speech” including but not limited to speech consistency features (for example, accent consistency, voice pitch consistency, voice tone consistency, tempo consistence), syllable emphasis features, and features related to the amount of time between consecutive words.

### Use Scenario 3

Use scenarios 1 and 2 related to the situation where it is desired to distinguish between computer-generated responses and human-generated responses. In particular, use scenarios 1 and 2 related to the situation where it is desired to only provide a computer service to a “live human” rather than to an automated “computer robot.”

Use scenario 3 relates to the situation where it is desired to only provide the computer service to a select demographic group or groups. In one example, it is desired to only provide a computer service to women this service may be some sort of “women-only chat service.” In another example, adult content is only distributed to people over the age of 20, and it is desired to only provide the “adult content electronic distribution service” to bona fide users over the age of 20.

According to this example, the CAPTCHA challenge is used in order filter out automated responses—for example, a fraudster submitting a pre-recorded sample of a user in the “correct” demographic category (for example, a 50 year old person speaking “generic” words). In this example, the computer service is only provided to client machines from which a voice response to the CAPTCHA challenge is received that: (i) is a “correct” response to the CAPTCHA challenge—this helps to ensure that the response is provided “live” and reduces the risk that a fraudster will automatically and successfully submit a pre-recorded “generic” voice response from a person who is a member of the “required” demographic group and (ii) is determined to be electronic voice content from a member of the “required” demographic group—this reduces the risk that a “live” person that is not a member of the required demographic group (for example, a pre-teen trying to access an ‘adults-only’ web site) will attempt to gain access by providing a “correct” response to the CAPTCHA challenge.

In this example, one or more speech delivery features may be analyzed to determine if the voice response is provided from a member of the “required” demographic group.

### A DISCUSSION OF THE FIGURES

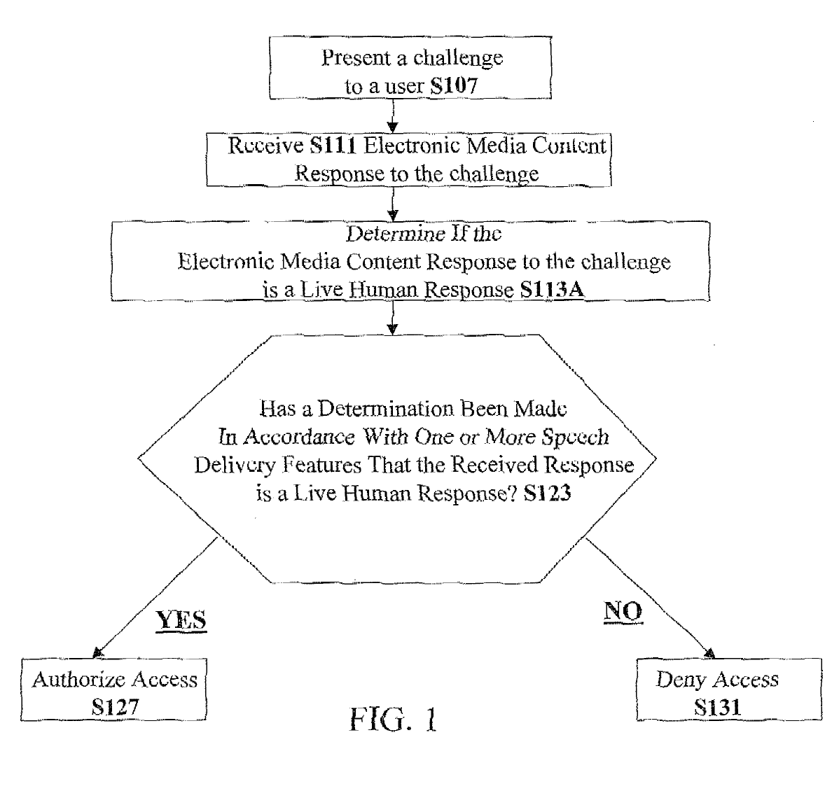

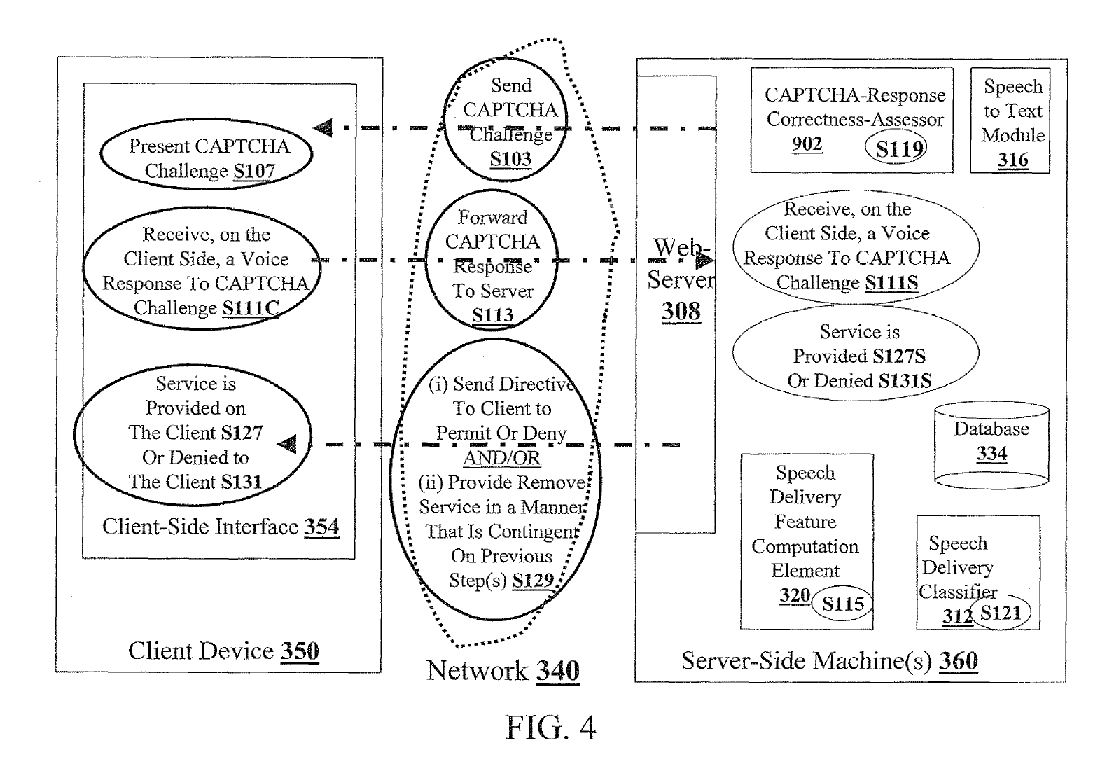

FIG. 1 is a flow chart of an exemplary routine for deciding whether or not to provide access to a computer service. In some embodiments, the routine of FIG. 1 is carried out in the system of FIG. 4 which includes a client device 350 (for example, a cell phone, PDA, laptop, table device, desktop, etc) in communications with one or more “server-side” machine(s) 360 via computer network 340.

Although the system of FIG. 4 is illustrated as a “client-server” system, it is noted that other embodiments, for example, client-only embodiments, are also contemplated. Furthermore, although the server 308 is shown as a “web server,” other types of servers (for example, not internet-based) are also appropriate.

In step S107, a challenge is provided to a user. In some embodiments, the challenge is provided in response to a user attempt to access online resources which are protected by the authorization system (for example, to open an email account, post information to a blog, access a telephony service, or to access any other computer service). The challenge may be presented visually and/or as an audio challenge.

In one example related to reCAPTCHA, one or more images of letters or numbers that are known be difficult for optical character recognition (ORC) systems to recognize is displayed on a display screen.

Other examples of challenges include but are not limited to: (i) requests to read a word, phrase, sentence or paragraph; (ii) requests to describe an image; (iii) requests to answer or solve a math problem; and (iv) a request to sing a song.

In some embodiments, the challenge is dynamically generated. For example, sentence may be randomly selected from a database of sentences to be read. Nevertheless, it is noted that this is not a requirement.

In some embodiments, challenge may be still or changing over time: picture vs. video, a paragraph with words constantly adding, etc.

Furthermore, in some embodiments, the challenge may also be a displayed brand name, logo or another form of commercial message, therefore monetizing the system through online advertising.

Some examples of various challenges are provided in a separate section below.

It is noted that presenting a challenge (either on the client device 350 itself or by sending information describing the challenge to the client device 350—for example, via computer network 340) is one example of ‘soliciting a user input.’

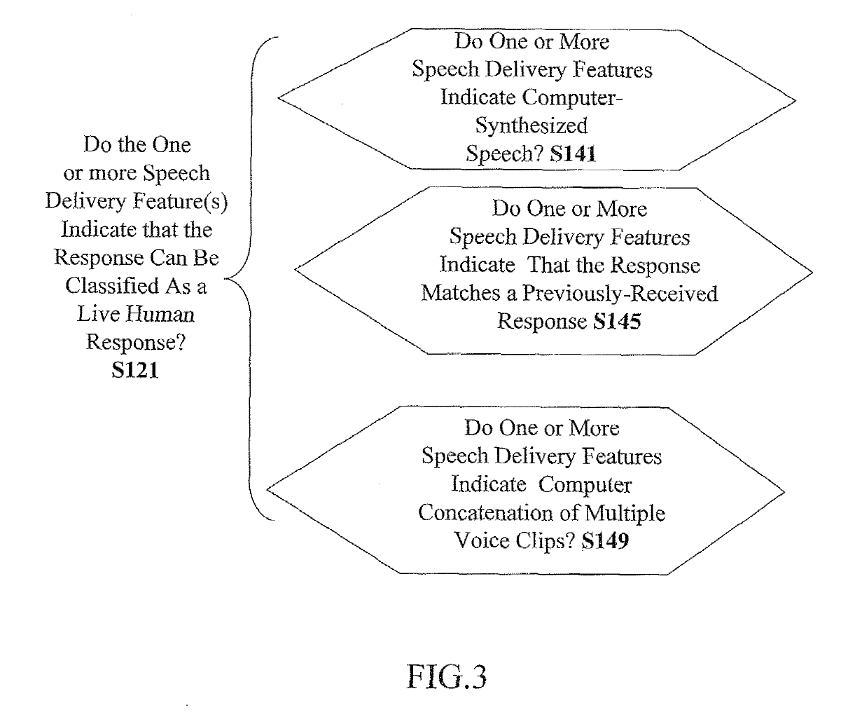

In step S111, a response to the challenge is received. In the example of FIG. 3, the response is first received S111C on the client side which forwards the response S113 via network 340 to web-server 308—then the response is received S111S on the server side.

In step S113, a determination is made (either on the client side and/or on the server side—in the example of FIG. 3 this is done on the server side) whether or not the electronic media content received in step S111 is from a human or from a computer.

In some embodiments, this is carried out using a “classifier” that is “trained” to distinguish between “live human responses” and responses other than “live human responses” (i.e. automated computer responses that employ computer-voice synthesis and/or use of “pre-recorded” speech). This is the “CAPTCHA” aspect of the technique—i.e. distinguishing between computers and human beings.

For the present disclosure, a “live human response” is a response from a human (i.e. as opposed from a computer) who speaks (i.e. generates the sound waves of the response) in a “live” time frame—i.e. after the time of the challenge presentation to the user of step S107. Various implementations of step S113 will be discussed in subsequent figures.

Referring to step S123, it is noted that if a determination has been made (i.e. either on the client side or the server side), in accordance with one or more speech delivery speeches, that the received response is a live human response, then access to the computer service is authorized (step S127) for the client device and/or user associated with the client device. Otherwise, a decision is made to deny access in step S131 Steps S123, S127 and/or S131 may be carried out on the client side and/or on the server side.

For the present disclosure, voice electronic media content is describable by two feature types: “speech content features” (i.e. the letters and/or numbers and/or words of the speech) and “speech delivery features”—i.e. describing how a given set of words is delivered by a given speaker.

Exemplary speech delivery features include but are not limited to: accent features (i.e. which may be indicative, for example, of whether or not a person is a native speaker and/or an ethnic origin), loudness features, breathing features, speech tempo features, voice pitch features (i.e. which may be indicative, for example, of an age of a speaker or gender of a feature), voice loudness features, voice inflection features (i.e. this may be related to a position of a word in a sentence), and pausing features (i.e. how a speaker pauses between words), and syllable emphasis features. Another “speech delivery feature” may relate to a person's “voice print.”

In the example of FIG. 1, the “authentication” (i.e. acting in accordance with a determination of whether or not the response of step S111 is a live human response) is may either be carried out either (i) only according to the one or more speech delivery features or (ii) in accordance with one or more speech delivery features and other features as well (for example, whether or not the response to the challenge is “successful”—.e.g whether or not the identification of the blurry letters is correct, whether or not the answer to the math problem is correct, etc).

This may be useful, for example, for reducing the number of “false positives” associated with submission, in step S111, of ‘pre-recorded’ speech, or useful for any other reason.

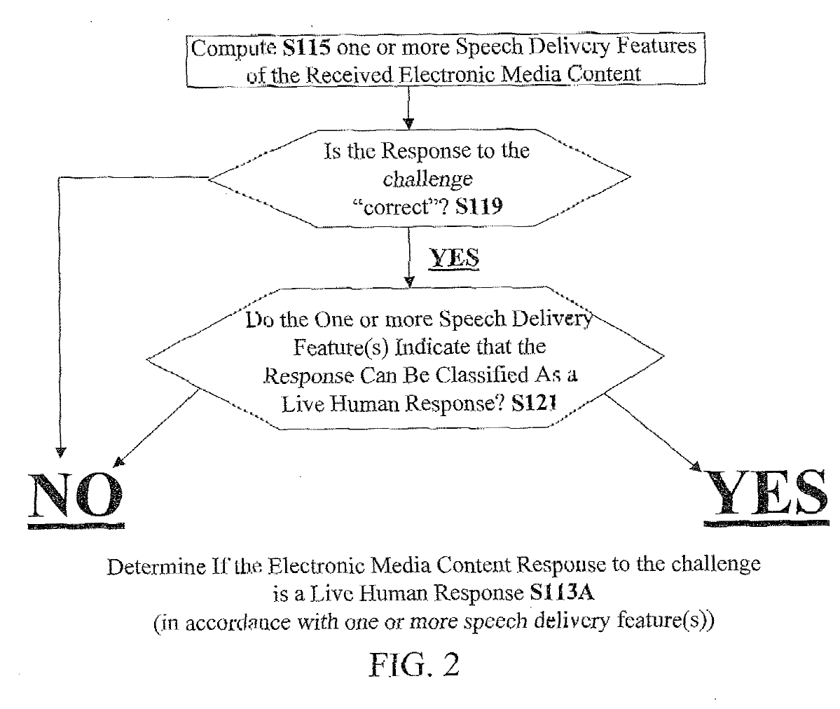

FIG. 2 is a flow chart of an exemplary implementation of step S113. In the example of FIG. 2 the authentication (i.e. that the response is indeed a live human response)

As with any FIG. in the present disclosure, the order of steps is illustrative and not limiting. For step 8119 may be performed after step S115.

FIG. 3 is a flow chart of an exemplary implementation of step S121.

According to the embodiment of FIG. 3, three alternative scenarios to the “live human response” are analyzed (i.e. using an appropriately-trained classifier). Thus, in step S141, it is ascertained whether or not the electronic media content received in step S111 includes “computer-synthesized speech”—i.e. from an electronic speech synthesizer, rather than from a human. It is understood that if the answer to the question of step S141 is “yes,” then the answer to the question of step S121 is “no.”

According to one implementation, a classifier may be trained to distinguish between “human-spoken” speech and “computer-synthesized” speech using a (i) a first “training set” of electronic media content of “human-spoken speech” and (ii) a second “training set” of electronic media content of computer synthesized speech.

Exemplary techniques include but are not limited to C45 trees, Hidden Markov Models, Neural Networks, or meta-techniques such as boosting or bagging. In specific embodiments, this statistical model is created in accordance with previously collected “training” data.

Appropriate statistical techniques are well known in the art, and are described in a large number of well known sources including, for example, Data Mining: Practical Machine Learning Tools and Techniques with Java Implementations bv lan H. Witten, Eibe Frank; Morgan Kaufmann, October 1999), the entirety of which is herein incorporated by reference.

The classifier may be trained to appropriately “weigh” various features.

In step S145, it is ascertained whether or not one or more speech delivery features indicate that the response matches a previously-received response. For example, a fraudster who tries to circumvent the system may ‘manually’ generate a database of human speech of the “correct answers” (i.e. manually record humans who ‘successfully’ answer the various CAPTCHAS). Then the fraudster could create a database, indexed by the text of the CAPTCHA (or any other description of the CAPTCHA). Then, when trying to gain authorization and access to the computer service at a later time, the fraudster may re-submit electronic media content (i.e. the recording of the human speaker) that had previously been used to gain successful access. Of course, this type of submission (i.e. in step S111) is typically automated and is not an example of a “live human response” (i.e. the human-generation of the sound took place before the challenge was presented).

According to one implementation of step S145, the response received in step S111, is compared with a database of previously-received response (for example, stored in database 330 which may be in any location). In the event that the response “matches” a previously received response (within some sort of “threshold” certainty), then the answer to the question of step S145 is “yes” and the answer to the question of step S121 is “no.”

In another example, rather than (or in additional to) looking for previously-submitted specific “sound clips” of “specific words,” it is known that the fraudsters are in possession of a “dictionary” of spoken words from a certain list of individuals (i.e. a “black list”). In this example, we compile a “black list” of voice characteristic of these individuals, whom it is suspected or known is associated with fraudsters trying to circumvent the “CAPTCHA” authorization system. In this example, we compare the received speech with “voice prints” of one or more individuals on the “black list” (even if the actual words do not match)—if the speech matches any “voice print” in the black list, we consider that the submission of step S111 is “suspect” and not likely to be a live human response.

It is noted that the aforementioned “black list” example is different from use a “white list”—where we only provide access to “pre-specified” human individuals (i.e. a white list). In the presently disclosed technique, there is no requirement to only provide access to certain pre-specified or pre-determined individuals (for example, credit card owners). Instead, it is possible to target “live human responses” and/or pre-determined genders and/or pre-determined age groups.

Reference is now made to step S149, which will be explained in terms of one non-limiting example. In this non-limiting example, the challenge presented in step S107 is a request to read the sentence “Patents applications are important.” In this example, when the fraudster (i.e. who wants to “automatically” be authorized without providing a live human response) encounters this challenge, the fraudster does not have available a sound clip of “Patent applications are important.” However, the fraudster does have the following three sound clips: Sound clip “A” of somebody reading the word “patent,” sound clip “B” of somebody reading “applications” and sound clip “C” of somebody reading the words “are important.” Thus, in this example, the fraudster will electronically concatenate these three sound clips and then submit in step S111.

In step S149, it is determined if one or more speech delivery features indicate computer concatenation of multiple voice clips. In the event that such features do indicate concatenation (for example, because (i) it is determined that the submitted clips include clips from different human speakers (for example, an older male and a young girl, or from different of the same age and/or gender with different “voice-prints”) and/or (ii) because the syllable emphasis of various one or more words is inconsistent with their place in the sentence and/or (iii) because the breathing patterns are inconsistent with a ‘coherent’ single sentence and/or (iv) for any other reason—like any other classification or feature, this is may be determined according to some minimal likelihood threshold), then the conclusion of step S149 is ‘yes’ and the conclusion of step S121 is ‘no’ (i.e. because electronically-concatentated speech is not a ‘live human response’).

In another example (not shown in the figures), the accent of the response received in step S111 is associated with a certain region of the world of the United States or a certain ethnicity (for example, a Texas accent, a Boston accent, a Chinese accent, etc). Furthermore, the locale of the client device is assessed (for example, from an IP address, a phone number area code, or any other way). In this example, the locale of the accent is compared with the locale of the client device 350. In the event of a mismatch (for example, a Boston accent in the middle of Montana), then this increases the likelihood (but not necessarily to 100%—in many examples, this feature is combined with other features) that the response received in step S111 is not a live human response.

Reference is now made to FIG. 4. It is noted that not every element in FIG. 4 is required, other elements may be added, and any element (shown or not depicted) may be implemented in any combination of hardware and/or software. Furthermore, as noted above, “client-only” implementations are also contemplated.

In the example of FIG. 4, the CAPTCHA challenge is sent S103 from server 308 (including but not limited to a web server) to client device 350 via network 340 (for example, an internet or a cellular network or any other computer network). In one example, the CAPTCHA challenge is generated by a CAPTCHA generation engine—for example, operative to provide a CAPTCHA challenge that is random at least in part.

It is noted that “sending the CAPTCHA challenge” is one example of “soliciting user input” from the server side. Presenting the CAPTCHA challenge in step S107C on the client side (either visually on a display screen (not shown)) or in an audio manner using a speaker (not shown) is another example.

After receiving the response on the client side in step S111C (via a microphone and/or video camera (NOT SHOWN)), (where C stands for “client side” and S stands for “server side”) the response is forwarded to the server in step S113. In the example of FIG. 4, the response is analyzed on the server side in order to assess if the response(i.e. delivered to client device 350) is a live human response or not.

After the response (i.e. electronic media content) is received on the server side S111C, a determination is made (shown in FIG. 1 and not in FIG. 4) whether or not the response is a live human response. Towards this end, in some embodiments, a CAPTCHA-response correctness assessor 902 analyzes the text of the submitted response to the CAPTCHA challenge, and determines whether or not the response is “correct” (for example, whether or not the “correct” words of the sentence were read or the correct letter(s) and/or word(s) and/or number(s) were identified from the “blurry” image. Towards this end, a speech to text module 316 for extracting the words of the response (i.e. speech “content” features) may be used.

In step S115, one or more “speech delivery features” are determined, for example, by “speech delivery feature computation element 320.” Upon computing the one or more features, it is possible to “classify” the speech delivery features (using Speech Delivery Classifier) 312 to effect the determination of step S121.

In accordance with the determination of step S123 (not shown in FIG. 4) a decision is made to provide or deny access to the service. The providing or denying is carried out (in the example of FIG. 4) both on the server side (S127S and S131S) as well as the client side (S127C and S131C) (after the appropriate communication is sent in step S129).

### ADDITIONAL EXAMPLES OF CAPTCHA CHALLENGES

Example of sentence challenge: The CAPTCHA system challenges the user by displaying “Good morning America” on the screen. The user must read out loud the sentence to the microphone in order to get through the CAPTCHA. The speech input is recorded, and analyzed with a speech recognition engine and the input is then compared to the expected result. If the system determines that the user correctly identified the challenge, the user is granted permission to proceed. Otherwise, access is denied and the user is asked to respond to a different challenge.

Example of an image challenge: The system displays an image of a parrot and asks the user to describe the image. The system will authorize (see step S119) the user only if he said “parrot” or “bird”.

Example of equation: The system displays an equation—“(3×2)+4” and asks the user to say the result of the equation. The system will authorize the user (see step S119) only if he said “ten”.

Example of sound clip: The system plays a sound of a bird chirping and requests the user to identify the sound. The system will authorize the user said “bird” (see step S119).

Example of mixed sound clip & text: The system plays a sound of two gun-shots, Along with a question: “What is the sound you heard and how many times?”, The system will authorize (see step S119) the user only if he said “two gunshots” or “gunshot, two times”.

Example of video clip: The system plays a video clip of a clown jumping up and down, and requests the user answer the question “what is the clown doing?”. The system will authorize (see step S119) the user said “jumping”.

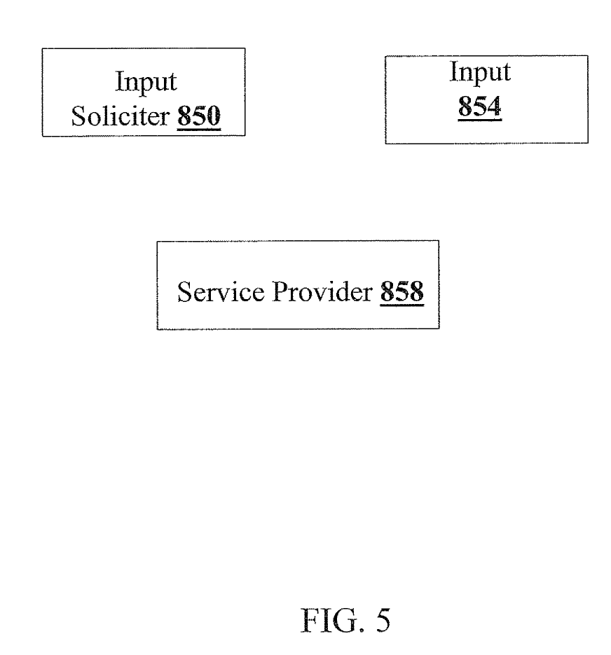

### Discussion of FIG. 5

FIG. 5 is a block diagram of apparatus and for user authentication. Each element of FIG. 5 may be implemented in any combination of hardware and/or software, on the client 350 and/or on one or more serve machines 360, may be implemented locally and/or in a distributed manner. In some embodiments, one or more elements are the combination of a processor executing computer-readable code.

The apparatus of FIG. 6 includes: a) an input-soliciter 850 operative to solicit a user input (for example, a server which, upon execution of code, sends a CAPTCHA challenge in step S103, and/or a client device which upon execution of code, presents the challenge in step S107 either visually or by sound); b) an input 854 (for example, a microphone on the client side and/or any electronic port and/or software or hardware interface operative to receive an electronic media content) , operative to receive, on or from a client device, a voice response (i.e. either sound waves of the voice response and/or electronic media content of the response) to the input soliciting; c) a service-provider (for example, computer code which may be executed on the server and/or client and/or the server and/or client configured to have this behavior) operative to: i) if a determination is made, in accordance with one or more speech delivery features of the voice response, that the voice response is a live human voice response, permit the client device to access a computer service; and ii) otherwise, deny client device access to the computer service.

### Additional Filter for Pre-Specified Gender and/or Age Group

In some embodiments (NOT SHOWN IN FIGS), access it not provided to every client device for which it is determined that a live human response has been provided. Instead, access is provided to a target pre-determined gender (for example, we only want to give access to a “woman-only” chat-room to females) or a pre-determined age (for example, we want to prevent the provisioning of adult content to children or teens). In these embodiments, one or more speech delivery features may be used to determine the gender and/or age the user providing the response (for example, voice tone or hair length for examples related to video conferencing for determining gender—voice tone or speech rate may also be useful for determining age).

### Conclusion

It is further noted that any of the embodiments described above may further include receiving, sending or storing instructions and/or data that implement the operations described above in conjunction with the figures upon a computer readable medium. Generally speaking, a computer readable medium may include storage media or memory media such as magnetic or flash or optical media, e.g. disk or CD-ROM, volatile or non-volatile storage media such as RAM, ROM, etc. as well as transmission media or signals such as electrical, electromagnetic or digital signals conveyed via a communication medium such as a network and/or wireless links.

Once again, it is noted that this is not to be confused with a “white list” of requiring a match with one or more “pre-specified” or “pre-determined” users (for examples, a specific credit card holder or a spouse of a credit card holder).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

All references cited herein are incorporated by reference in their entirety. Citation of a reference does not constitute an admission that the reference is prior art.

The articles “a” and “an” are used herein to refer to one or to more than one (i.e., to at least one) of the grammatical object of the article. By way of example, “an element” means one element or more than one element.

The term “including” is used herein to mean, and is used interchangeably with, the phrase “including but not limited” to.

The term “or” is used herein to mean, and is used interchangeably with, the term “and/or,” unless context clearly indicates otherwise.

The term “such as” is used herein to mean, and is used interchangeably, with the phrase “such as but not limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1) A method of authentication, the method comprising:
a) soliciting a user input;
b) receiving, on or from a client device, a voice response to the input soliciting;
c) if a determination is made, in accordance with one or more speech delivery features of the voice response, that the voice response is a live human voice response, permitting the client device to access a computer service; and
d) otherwise, denying client device access to the computer service.

2) The method of claim 1 wherein the access permitting to the computer service of step (c) does not require a match between features of the received voice response and speech features of one or more pre-specified human individuals.

3) The method of claim 1 wherein the determination that the voice response is a live human voice response is contingent on a determination that the voice response is not concatenated sound clips.

4) The method of claim 1 wherein the determination that the voice response is a live human voice response is contingent on a determination that the voice response does not match electronic media content generated before a time of the soliciting.

5) The method of claim 1 wherein the determination that the voice response is a live human voice response is contingent on a determination that the voice response does not include computer synthesized speech.

6) The method of claim 1 wherein the determination that the voice response is a live human voice response is contingent on a determination that the voice response is not a multi-speaker voice response.

7) The method of claim 1 wherein the computer service is selected from the group consisting of the provisioning of a phone call, a gaming service, an email server, and a web browsing service.

8) The method of claim 1 wherein:
i) the input-soliciting includes presenting a dynamically-generated challenge is that is randomly-generated at least in part; and
ii) the determination that the voice response is a live human response is contingent upon the voice response including a successful response to the challenge.

9) The method of claim 1 wherein:
i) the input-soliciting includes presenting at least one challenge selected from the group consisting of:
A) a request to read a sentence;
B) a request to describe an image or a video clip;
C) a request to answer a math problem; and
D) a request to sing a song; and
ii) the determination that the voice response is a live human response is contingent upon the voice response including a successful response to the challenge

10) The method of claim 1 wherein the method is repeated a plurality of times for a plurality distinct human users, the method further comprising:
e) identifying words of the voice responses;
f) generating, from the received voice response, a database of response from different users; and
g) indexing the database by word.

11) A method of authentication, the method comprising:
a) soliciting a user input;
b) receiving, on or from a client device, a voice response to the input soliciting;
c) if a determination is made that the voice response is a live human voice response from of person of a pre-determined gender or a pre-determined age range, permitting the client device to access a computer service; and
d) otherwise, denying client device access to the computer service.

12) The method of claim 11 wherein the access permitting to the computer service of step (c) does not require a match between features of the received voice response and speech features of one or more pre-specified human individuals.

13) An apparatus for authentication, the apparatus comprising:
a) an input-soliciter operative to solicit a user input;
b) an input, operative to receive, on or from a client device, a voice response to the input soliciting;
c) a service-provider operative to:
i) if a determination is made, in accordance with one or more speech delivery features of the voice response, that the voice response is a live human voice response, permit the client device to access a computer service; and
ii) otherwise, deny client device access to the computer service.

14) The apparatus of claim 13 wherein the service-provide is operative such that the access permitting to the computer service does not require a match between features of the received voice response and speech features of one or more pre-specified human individuals.

15) An apparatus for authentication, the apparatus comprising:
a) an input-soliciter operative to solicit a user input;
b) an input, operative to receive, on or from a client device, a voice response to the input soliciting;
c) a service-provider operative to:
i) if a determination is made, in accordance with one or more speech delivery features of the voice response, that the voice response is a live human voice response from of person of a pre-determined gender or a pre-determined age range, permit the client device to access a computer service; and
ii) otherwise, deny client device access to the computer service.

16) The apparatus of claim 15 wherein the service-provide is operative such that the access permitting to the computer service does not require a match between features of the received voice response and speech features of one or more pre-specified human individuals.
